(19) United States
(12) Patent Application Publication
(10) Pub. No.: US 2020/0064937 A1
(43) Pub. Date: Feb. 27, 2020

(54) ACTIVE PEN TRUE ID

(71) Applicant: FlatFrog Laboratories AB, Lund (SE)

(72) Inventors: Ola WASSVIK, Lammhult (SE); Magnus HOLLSTRÖM, Lund (SE); Markus ANDREASSON, Lund (SE); Nicklas OHLSSON, Bunkeflostrand (SE)

(21) Appl. No.: 16/461,177

(22) PCT Filed: Dec. 6, 2017
(86) PCT No.: PCT/SE2017/051224

§ 371 Date: May 15, 2019

(30) Foreign Application Priority Data
Dec. 7, 2016 (SE) 1630293-7

(51) Int. Cl. G06F 3/0354; G06F 3/041; G06F 3/044; G06F 3/0488

(52) U.S. Cl. CPC G06F 3/03545; G06F 3/0416; G06F 2203/04104; G06F 3/0414; G06F 3/04883; G06F 3/044

(57) ABSTRACT

A method of controlling an interaction between a stylus and a touch sensitive device is disclosed. The stylus comprises a unique identifier and a wireless transmitter for wireless transmission of the unique identifier. The touch sensitive device comprises a wireless receiver for wirelessly receiving the unique identifier of one or more styluses. The method comprises transmitting the unique identifier from a first stylus to the touch sensitive device, determining from a database, a set of controls associated with the unique identifier, and controlling the interaction between the touch sensitive device and the user of the first stylus according to the set of controls. A touch interaction system is also disclosed.

### TECHNICAL FIELD

The present invention relates to techniques for detecting and uniquely identifying styluses and other objects to be used with a touch sensitive device.

### BACKGROUND

Various user identification techniques are employed in touch applications in order to distinguish different users, such as biometric techniques, or techniques based on distinguishing different gestures. By being able to distinguish different users, it is also possible to control the interaction with the touch application depending on the identified user. This allows for customizing the touch interaction to the specific user. This also opens up for user authentication procedures. A problem with previous techniques such as those using a fingerprint scanner, is increased complexity and costs. Also, gesture control can be cumbersome and slow down the user experience. In many situations, the user may also refrain from using such identification procedures due to the added complexity. This will hinder the development with respect to user customization or user security in touch applications.

Hence, an improved method of identifying unique styluses and users would be advantageous and in particular allowing for avoiding more of the above-mentioned problems and compromises.

### SUMMARY

Accordingly, examples of the present invention preferably seek to mitigate, alleviate or eliminate one or more deficiencies, disadvantages or issues in the art, such as the above-identified, singly or in any combination by providing a device according to the appended patent claims.

According to a first aspect a method of controlling an interaction between a stylus and a touch sensitive device is provided. The stylus comprises a unique identifier and a wireless transmitter for wireless transmission of the unique identifier. The touch sensitive device comprises a wireless receiver for wirelessly receiving the unique identifier of one or more styluses, and an interactive display controllable with touch interactions. The method comprises transmitting the unique identifier from a first stylus to the touch sensitive device; determining from a database, a set of controls associated with the unique identifier; and controlling the interaction between the touch sensitive device and the user of the first stylus according to the set of controls.

According to a second aspect a touch interaction system is provided, comprising a first stylus comprising a wireless transmitter adapted to transmit a unique identifier. The touch interaction system further comprises a touch sensitive device comprising a receiver adapted to receive the unique identifier from the first stylus, and an interactive display controllable with touch interactions. The touch interaction system further comprises a control unit adapted to transmit the unique identifier from the first stylus to the touch sensitive device; determine from a database, a set of controls associated with the unique identifier, and control the interaction between the touch sensitive device and the user of the first stylus according to the set of controls.

Further examples of the invention are defined in the dependent claims, wherein features for the second and subsequent aspects of the invention are as for the first aspect mutatis mutandis.

Some examples of the disclosure provide for a simpler stylus—or user identification system.

Some examples of the disclosure provide for stylus—or user identification which is more intuitive.

Some examples of the disclosure provide for a less costly stylus—or user identification system.

Some examples of the disclosure provide for a more reliable and robust stylus—or user identification system.

Some examples of the disclosure provide for a more flexible and adaptable stylus—or user identification system.

Some examples of the disclosure provide for a stylus—or user identification system which is quicker to use.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

These and other aspects, features and advantages of which embodiments of the invention are capable of will be apparent and elucidated from the following description of embodiments of the present invention, reference being made to the accompanying drawings:

FIG. 1 is a schematic illustration of a touch interaction system according to one example, in which;

FIG. 1a is a schematic illustration of a stylus according to one example; and

FIG. 1b is a schematic illustration of a touch device and styluses according to one example.

FIG. 2 is a schematic illustration of a touch interaction system according to one example.

FIG. 3 is a schematic illustration of different users of a touch interaction system according to one example.

### DETAILED DESCRIPTION

Specific examples of the invention will now be described with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art. The terminology used in the detailed description of the embodiments illustrated in the accompanying drawings is not intended to be limiting of the invention. In the drawings, like numbers refer to like elements.

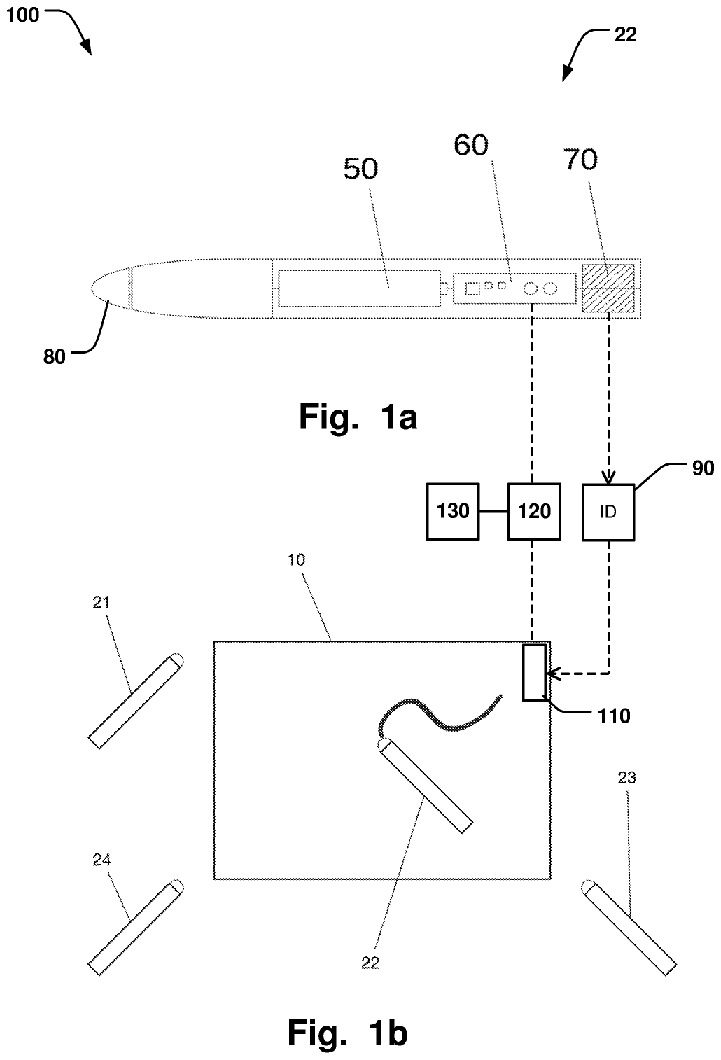

FIGS. 1a-b show a touch interaction system 100 comprising a first stylus 22 and a touch sensitive device 10. The stylus 22 comprises a wireless transmitter 70 adapted to transmit a unique identifier 90, and the touch sensitive device 10 comprises a receiver 110 adapted to receive the unique identifier 90 from the first stylus 22. The stylus 22 may be a first stylus among a plurality of styluses 21, 22, 23, 24, in the touch interaction system 100. The receiver 110 may be adapted to receive a unique identifier 90 from each of the plurality of styluses 21, 22, 23, 24. The touch interaction system 100 comprises a control unit 120 adapted to transmit the unique identifier 90 from the first stylus 22 to the touch sensitive device 10. The control unit 120 communicates with the first stylus 22 and the touch sensitive device 10, and is further adapted to determine, from a database 130, a set of controls associated with the unique identifier 90. The communication between the control unit 120 and the mentioned components in the touch interaction system 100 may be wireless communication. It is conceivable that the stylus 22 or the touch sensitive device 10 may comprise the control device 120. In case the touch sensitive device 10 comprise the control device 120, the stylus may have a stylus control device 60 adapted to communicate with the control device 120, via the transmitter 70 and receiver 110. Upon receiving a first unique identifier 90 the control unit 120 is adapted to identify a first set of controls stored in the database 130 that are associated with the first unique identifier 90. The control unit 120 is further adapted to control the interaction between the touch sensitive device 10 and the user of the first stylus 22 according to the set of controls that has been identified for the received unique identifier 90. Thus, this provides for a simple and effective procedure to associate a set of rules, i.e. a set of controls, to a particular stylus and user thereof. Several users may accordingly have their personal styluses 21, 22, 23, 24, each having a unique identifier 90, that will have an associated set of controls stored in the database 130, allowing for the control unit 120 to distinguish and associate each of the users to the particular set of controls to customize and regulate the particular user's interaction with the touch sensitive device 10. This allows, for example, setting different authorization levels for a plurality of styluses and users. E.g. an administrator 301 (FIG. 3) may have a stylus 21 that transmits a first unique identifier 90 associated with a set of controls that allows administrator interaction with the touch sensitive device 10, whereas a sub-user 302 has a stylus 22 that transmits a second unique identifier 90′ which is associated with another set of controls that allows restricted or different interaction with the touch sensitive device 10.

Thus, a method of controlling an interaction between a stylus 22 and a touch sensitive device 10 is provided. The method comprises transmitting the unique identifier 90 from a first stylus 22 to the touch sensitive device 10, determining from a database 130, a set of controls associated with the unique identifier 90, and controlling the interaction between the touch sensitive device 10 and the user of the first stylus 22 according to the set of controls.

The unique identifier 90 may be transmitted upon contact between the first stylus 22 and the touch sensitive device 10. It is thus possible to synchronize the user's interaction with the touch sensitive device 10 and the unique set of controls that should apply to that particular event of interaction. I.e. once a user engages a first stylus 22 in contact with the touch sensitive device 10, the first unique identifier 90 is transmitted, received and associated with the corresponding set of first controls that dictates the rules that should apply to the interaction detected at the time of sensing the user's contact with the touch sensitive device 10. This allows for a simple and effective distinguishing between several users that may, for example, have different authorization levels. E.g., any control setting associated with an administrator—or higher authorization level applies only to the interactions, i.e. events of contact in time, carried out by a user having a stylus identified as authorized to interact at such level.

A time stamp may be transmitted from the first stylus 22 to the touch sensitive device upon contact between the first stylus 22 and the touch sensitive device 10. The method may comprise comparing this time stamp with the time of a registered touch event of the first stylus 22 at the touch sensitive display. It is thus possible to distinguish touch events occurring in fast sequences in time and synchronise these events with the set of controls that should apply for each event, depending on which of the styluses, among the plurality of styluses 22, 23, 24, 25, that contacts the touch sensitive device 10, and send the unique identifier 90 at that particular event.

Thus, the control unit 120 may be adapted to transmit the unique identifier 90 upon contact between the first stylus 22 and the touch sensitive device 10, and adapted to generate a time stamp that is transmitted from the first stylus 22 to the touch sensitive display 10 upon said contact. The control unit 120 may be further adapted to compare the time stamp with the time of a registered touch event of the first stylus 22 at the touch sensitive display 10.

The touch event may be registered based on a passive touch interaction between the first stylus 22 and the touch sensitive display 10. Thus, is not needed to have active detection of the stylus 22 touch event to register the input on the touch sensitive display 10. It is sufficient to detect the point in time the stylus contacts, or possibly come in to close contact, with the touch sensitive display 10. This reduces the complexity of the stylus 22, while still being able to distinguish input as described above. The time of contact may be registered by a distal detection unit 80 at the stylus 22, such as a mechanical, electrical or optical sensor. The distal detection unit 80 may for example comprise a pressure sensor or any electro-mechanical actuator being adapted to register a pushing action of the stylus against the touch sensitive device 10.

Controlling the interaction between the touch sensitive device 10 and the first stylus 22 may comprise providing access to the user of the first stylus 22 to an operating system account or application account identified by the set of controls. It is thus possible for a user to get access to designated accounts that are approved for the user's particular stylus 22.

Access for the user of the first stylus 22 to the operating system account or application account may be disabled a set period of time after the last interaction between the first stylus and the touch sensitive device. This may be advantageous in certain authorization environments, where a time limited access to the accounts is desirable, which may be the case when styluses are re-used after a certain period of time.

Access for the user of the first stylus to the operating system account or application account may be disabled a set period of time after the last received wireless transmission between the first stylus and the touch sensitive device. This further improves security since proximity to the touch sensitive device 10 may be required to maintain the set authorization level and access.

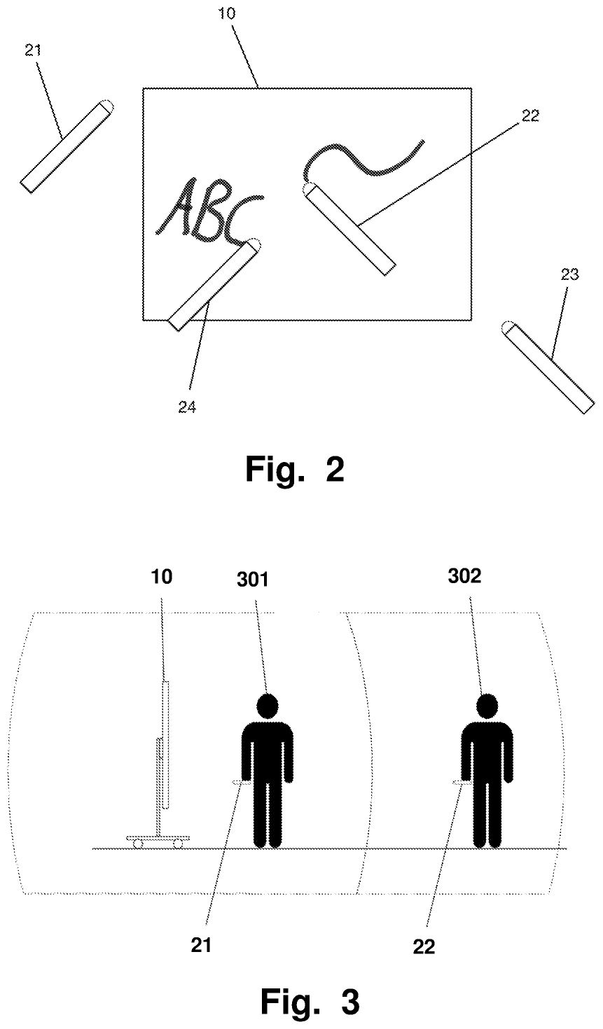

Controlling the interaction between the touch sensitive device and the first stylus may comprise controlling characteristics of the interaction input provided by the first stylus. Thus, characteristics of the input can be tailored to the different needs of the user. This may be advantageous when several users interact with a shared touch sensitive device 10, such as schematically illustrated in FIG. 2.

Controlling characteristics of the interaction input provided by the first stylus may for example comprise one or more of the following; i) controlling the colour of a digital ink applied using the first stylus 22 on the touch sensitive device 10; ii) controlling a brush configuration of a digital ink applied using the first stylus 22 on the touch sensitive device 10; iii) controlling a latency of interaction input provided by the first stylus 22 on the touch sensitive device 10; iv) controlling post processing of interaction input provided by the first stylus 22 on the touch sensitive device 10; or v) controlling a function of a secondary stylus tip 23 with respect to the touch sensitive device 10.

Controlling characteristics of the interaction input provided by the first stylus 22 may comprise visibly and distinctly associating input from each stylus 22, 23, 24, 25, to the respective stylus. It is thus possible to easily distinguish the input provided by the different styluses 22, 23, 24, 25.

Controlling the interaction between the touch sensitive device 10 and the first stylus 22 may comprise limiting editing of digital objects, created by or associated with the first stylus, to the first stylus. Limiting the editing of objects may be desirable in, for example, digital authentication procedures where a signature is required, e.g. when digitally signing a contract. I.e. once the authorization is given, by providing a signature, there is no possibility to cancel the authorization or signing. This provides for a more secure and reliable digital signing procedure to the users involved.

Controlling the interaction between the touch sensitive device 10 and the first stylus 22 may comprise limiting interaction input from the first stylus 22 to a first portion of the interactive display, wherein the first portion is defined by the set of controls. This advantageously provides for the possibility to restrict or grant access to interact with certain portions of the touch display device 10 for a particular stylus user. Each user may then have the ability to interact with different portions of the display depending on the set of controls associated with each of the styluses and users. It may for example be desirable to limit the interaction in a transactional application, used by a seller and buyer, so that the buyer may interact with a signing portion or field of the display only, and not with the remaining interaction fields such as the amounts payable.

Controlling the interaction between the touch sensitive device 10 and the first stylus 22 may comprise providing a first portion of the interactive display with one or more applications or UI elements customised in dependence on the set of controls. This further provides for the ability to customize the user experience or authorization level to the particular stylus and user.

The location and/or size of the first portion of the interactive display may be dependent on an interaction position of the first stylus 22 on the touch sensitive device 10. Thus, it is possible to adapt the first portion depending on the interaction with the first stylus.

The transmission of the unique identifier from the first stylus 22 to the touch sensitive device 10 may occur only in response to an indication from a biometric sensor 50 located on the pen identifying an authorised user. This provides for further increasing the security level, since the set of controls defining the rules for interaction with the touch sensitive device is linked to the particular user's biometric data.

The method may further comprise transmitting a biometric value from a biometric sensor located on the pen to the touch sensitive device in combination with the unique identifier, and wherein the set of controls is determined in dependence on the unique identifier and the biometric value. As mentioned, this provides for uniquely associating the interaction with the touch sensitive device 10 with a user' biometrical input, such as a fingerprint.

The method may further comprise transmitting the unique identifier 90 from a second stylus 23 to the touch sensitive device, and determining from the database, a set of controls associated with the unique identifier of the first stylus 22 in combination with the unique identifier of the second stylus 23. It is thus possible to have a different set of controls and rules for the interaction when more than one user interacts with the touch sensitive device 10. This provides for adapting the above-mentioned interaction to a plurality of users, such as the style or features of the UI or applications, or authorisation requirements, e.g. signing or access to an application is only possible when two users are present.

Controlling the interaction between the touch sensitive device and the first stylus may comprise, in dependence on the set of controls, identifying a user ID and providing an authentication interface to allow the user of the first stylus to authenticate against the identified user ID. Thus, a user may have a personal stylus 22, which transmit a user ID with the unique identifier 90. But in order for the set of controls associated with the unique identifier to be activated, the user is required to sign or otherwise authenticate that he or she is in fact owner of the user ID.

The step of providing an authentication interface may comprise enabling the user of the first stylus 22 to provide a signature using the first stylus to authenticate themselves. As elucidated above, this provides increased security and reliability, without having to incorporate biometric sensing etc.

The step of providing an authentication interface may comprise enabling the user of the first stylus to provide a passcode using the first stylus to authenticate themselves. This is one possibility for user ID confirmation. Alternatively, or in addition, the step of providing an authentication interface may comprise enabling the user of the first stylus to provide a geometric pattern using the first stylus to authenticate themselves. Alternatively, or in addition, the step of providing an authentication interface may comprise enabling the user of the first stylus to provide a tap sequence using the first stylus to authenticate themselves.

The authentication interface may be configured to not display the input interaction from the first stylus. The provides for increased security and privacy, since it will be more difficult for other nearby users to identify the input.

In any of the above embodiments, public-key cryptography or equivalent system may be used to ensure secure communication between a stylus and the touch sensitive device. The use of a cryptography system such as public-key cryptography also ensures that the unique identifier of a stylus cannot be replayed at a later date to allow authorisation to an attacker.

In any of the above embodiments, database 130 may be stored locally to control unit 120, i.e. as part of the same device. Alternatively, database 130 may be stored remotely, e.g. on a remote server. In such an embodiment, touch interaction system 100 comprises a network connection to allow control unit 120 to contact and retrieve data from remote database 130. The network connection may comprise a wireless or wired network connection, provided either directly to component 120 or to a device hosting component 120. This embodiment allows remote database 130 to be shared between more than one touch interaction system e.g. via the internet. This allows the portability of styluses, their unique identifiers, and the corresponding interaction controls and/or authentications between different touch interaction systems. In one example, a single administrator stylus may be provided with a same set of controls across a plurality of touch systems that allow administrator interaction.

The present invention has been described above with reference to specific embodiments. However, other embodiments than the above described are equally possible within the scope of the invention. The different features and steps of the invention may be combined in other combinations than those described. The scope of the invention is only limited by the appended patent claims.

More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used.

1-25. (canceled)

26. A method of controlling an interaction between a stylus and a touch sensitive device,
the stylus comprising a unique identifier and a wireless transmitter for wireless transmission of the unique identifier,
the touch sensitive device comprising a wireless receiver for wirelessly receiving the unique identifier of one or more styluses, and an interactive display controllable with touch interactions,
wherein the method comprises:
transmitting the unique identifier from a first stylus to the touch sensitive device,
determining from a database, a set of controls associated with the unique identifier,
controlling the interaction between the touch sensitive device and the user of the first stylus according to the set of controls,
wherein the unique identifier is transmitted upon contact between the first stylus and the touch sensitive device, and
wherein a time stamp is transmitted from the first stylus to the touch sensitive device upon said contact, the method further comprising comparing the time stamp with the time of a registered touch event of the first stylus at the touch sensitive display, the registered touch event being registered in dependence on a passive detection by the touch sensitive device of an interaction between the first stylus and the touch sensitive display.

27. The method of claim 26, wherein controlling the interaction between the touch sensitive device and the first stylus comprises providing access to the user of the first stylus to an operating system account or application account identified by the set of controls.

28. The method of claim 27, wherein access for the user of the first stylus to the operating system account or application account is disabled a set period of time after the last interaction between the first stylus and the touch sensitive device.

29. The method of claim 27, wherein access for the user of the first stylus to the operating system account or application account is disabled a set period of time after the last received wireless transmission between the first stylus and the touch sensitive device.

30. The method of claim 26, wherein controlling the interaction between the touch sensitive device and the first stylus comprises controlling characteristics of the interaction input provided by the first stylus.

31. The method of claim 30, wherein controlling characteristics of the interaction input provided by the first stylus comprises one or more of the following:
controlling the colour of a digital ink applied using the first stylus on the touch sensitive device,
controlling a brush configuration of a digital ink applied using the first stylus on the touch sensitive device,
controlling a latency of interaction input provided by the first stylus on the touch sensitive device,
controlling post processing of interaction input provided by the first stylus on the touch sensitive device, controlling a function of a secondary stylus tip with respect to the touch sensitive device.

32. The method of claim 30, wherein controlling characteristics of the interaction input provided by the first stylus comprises visibly and distinctly associating input from each stylus to the respective stylus.

33. The method of claim 26, wherein controlling the interaction between the touch sensitive device and the first stylus comprises limiting editing of digital objects created by or associated with the first stylus to the first stylus.

34. The method of claim 26, wherein controlling the interaction between the touch sensitive device and the first stylus comprises limiting interaction input from the first stylus to a first portion of the interactive display, wherein the first portion is defined by the set of controls.

35. The method of claim 26, wherein controlling the interaction between the touch sensitive device and the first stylus comprises providing a first portion of the interactive display with one or more applications or UI elements customised in dependence on the set of controls.

36. The method of claim 35, wherein the location and/or size of the first portion of the interactive display is dependent on an interaction position of the first stylus on the touch sensitive device.

37. The method of claim 26, wherein transmission of the unique identifier from the first stylus to the touch sensitive device occurs only in response to an indication from a biometric sensor located on the pen identifying an authorised user.

38. The method of claim 26, wherein the method further comprises transmitting a biometric value from a biometric sensor located on the pen to the touch sensitive device in combination with the unique identifier, and wherein the set of controls is determined in dependence on the unique identifier and the biometric value.

39. The method of claim 26, wherein the method further comprises:
transmitting the unique identifier from a second stylus to the touch sensitive device,
determining from the database, a set of controls associated with the unique identifier of the first stylus in combination with the unique identifier of the second stylus.

40. The method of claim 26, wherein controlling the interaction between the touch sensitive device and the first stylus comprises, in dependence on the set of controls, identifying a user ID and providing an authentication interface to allow the user of the first stylus to authenticate against the identified user ID.

41. The method of claim 40, wherein the step of providing an authentication interface comprises enabling the user of the first stylus to provide a signature using the first stylus to authenticate themselves.

42. The method of claim 40, wherein the step of providing an authentication interface comprises enabling the user of the first stylus to provide a passcode using the first stylus to authenticate themselves.

43. The method of claim 40, wherein the step of providing an authentication interface comprises enabling the user of the first stylus to provide a tap sequence using the first stylus to authenticate themselves.

44. The method of claim 40, wherein the authentication interface is configured to not display the input interaction from the first stylus.

45. A touch interaction system, comprising
a first stylus comprising a wireless transmitter adapted to transmit a unique identifier,
a touch sensitive device comprising a receiver adapted to receive the unique identifier from the first stylus, and an interactive display controllable with touch interactions, the touch interaction system further comprising
a control unit adapted to
transmit the unique identifier from the first stylus to the touch sensitive device,
determine from a database, a set of controls associated with the unique identifier, and
control the interaction between the touch sensitive device and the user of the first stylus according to the set of controls, and
wherein the control unit is adapted to:
transmit the unique identifier upon contact between the first stylus and the touch sensitive device,
generate a time stamp that is transmitted from the first stylus to the touch sensitive display upon said contact, and
compare the time stamp with the time of a registered touch event of the first stylus at the touch sensitive display, the registered touch event being registered in dependence on a passive detection by the touch sensitive device of an interaction between the first stylus and the touch sensitive display.
